(19) United States
(12) Patent Application Publication
(10) Pub. No.: US 2018/0314311 A1
(43) Pub. Date: Nov. 1, 2018

(54) TRANSMISSION APPARATUS, ELECTRONIC DEVICE, AND ACTIVATION CONTROL METHOD

(71) Applicant: FUJITSU LIMITED, Kawasaki-shi (JP)

(72) Inventors: Daijiro Tanaka, Fuchu (JP); Yoshinori Tochiki, Kawasaki (JP); Kenichi Yajima, Kawasaki (JP); Tetsuo Wada, Kawasaki (JP); Minyoung Bang, Kawasaki (JP)

(73) Assignee: FUJITSU LIMITED, Kawasaki-shi (JP)

(21) Appl. No.: 15/962,742

(22) Filed: Apr. 25, 2018

(30) Foreign Application Priority Data
May 1, 2017 (JP) 2017-091263

(51) Int. Cl. G06F 1/32

(52) U.S. Cl. CPC G06F 1/3206; G06F 1/3234

(57) ABSTRACT

An apparatus includes a processor that monitors a first operational status of processors, activates one of unactivated processors of the processors, and based on a second operational status of the activated processor, determines an activation timing of a next processor to activate next, and activates the next processor at the activation timing.

### CROSS-REFERENCE TO RELATED APPLICATION

This application is based upon and claims the benefit of priority of the prior Japanese Patent Application No. 2017-91263, filed on May 1, 2017, the entire contents of which are incorporated herein by reference.

### FIELD

The embodiments discussed herein are related to a transmission apparatus that transmits signals, an electronic device, and an activation control method.

### BACKGROUND

A transmitting and receiving apparatus (muxponder) is connected to a wavelength-division multiplexing (WDM) apparatus on the network of a WDM optical fiber communication system. The muxponder inputs and outputs optical signals with respect to the WDM apparatus, and inputs and outputs electrical signals converted from optical signals with respect to other routers.

For the optical signals handled by the muxponder, a transmission scheme such as DP-QPSK is adopted, and processes of transmitting and receiving the optical signals are executed by a quadrature modulation scheme (such as QPSK or 16QAM) using digital coherent transmitters and receivers. DP-QPSK stands for Dual Polarization Quadrature Phase Shift Keying, and QAM stands for Quadrature Amplitude Modulation.

The muxponder includes an optical transceiver and a digital signal processor (DSP). The DSP includes a forward error correction (FEC) coding section, a QPSK modulation section, and the like as functions on the transmitting side, and includes a dispersion compensation section, an adaptive equalization section, an FEC decoding section, and the like as functions on the receiving side. Herein, in the FEC decoding section on the receiving side, since the computational complexity generally increases as the number of error corrections increases, power consumption increases with worsening error rate of the signal input into the FEC decoding section. In the case in which there is a single DSP inside the apparatus, the power consumption in the FEC processing section that varies according to the number of error corrections in the receiver does not accumulate, and does not affect the maximum rating (maximum power consumption) demanded by the system as a whole.

In the attempt to design and operate WDM optical fiber communication systems with even faster transmission rates (exceeding 400 Gbps or 1 Tbps, for example), multiple modules (multiple DSPs) are provided inside the muxponder.

In the related art, there exist technologies that boot multiple DSPs at the same time, and shorten the boot time (for example, see Japanese Laid-open Patent Publication Nos. 2000-242611 and 2004-86415).

In the case in which multiple DSPs are included inside the muxponder, the maximum rating demanded by the system as a whole poses a problem. Ordinarily, since all DSPs start operating simultaneously from the instant of DSP activation (reset), the instantaneous maximum power consumption that occurs around the timing after DSP activation accumulates, and has a large peak. For this reason, the maximum rating of the apparatus is designed based on the peak in the instantaneous maximum power consumption that occurs around the timing of DSP activation.

If the activation timings of multiple DSPs are offset from each other by a timer or the like to reduce the peak in the instantaneous maximum power consumption, there is a possibility that the activation process of the next DSP may be initiated before the main signal is communicated. Also, if one attempts to secure a sufficient amount of time for the timer, activating all DSPs becomes time-consuming, the activation time of the muxponder as a whole becomes lengthy, and there is risk of no longer satisfying the demanded specifications of the muxponder, such as signal communication becoming unavailable. Also, even if one attempts to adjust the amount of time for the timer and control the timing at which to execute signal communication, the overall power consumption may vary due to fluctuations in the startup time of the adaptive equalization section, and as a result, raising the maximum rated power consumption demanded by the muxponder may be desired.

### SUMMARY

According to an aspect of the embodiments, an apparatus includes a processor that monitors a first operational status of processors, activates one of unactivated processors of the processors, and based on a second operational status of the activated processor, determines an activation timing of a next processor to activate next, and activates the next processor at the activation timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are block diagrams illustrating an exemplary internal configuration of a transmission apparatus according to Embodiment 1;

FIG. 2 is a block diagram illustrating a configuration related to DSP activation in the transmission apparatus according to Embodiment 1;

FIG. 3 is a diagram illustrating an exemplary hardware configuration of a control section of the transmission apparatus according to Embodiment 1;

FIG. 4 is a flowchart illustrating an exemplary control process executed by an activation control processor of the transmission apparatus according to Embodiment 1;

FIG. 5 is a graph illustrating the power consumption of an existing FEC processing section;

FIG. 6 is a time chart illustrating the transition of power consumption in an existing DSP;

FIG. 7 is a time chart illustrating the transition of power consumption in the case of activating multiple existing DSPs;

FIG. 8 is a time chart illustrating exemplary control of power consumption reduction in the case of activating multiple existing DSPs (1 of 2);

FIG. 9 is a time chart illustrating exemplary control of power consumption reduction in the case of activating multiple existing DSPs (2 of 2);

FIG. 10 is a time chart explaining exemplary control of DSP activation by the transmission apparatus according to Embodiment 1;

FIG. 11 is a block diagram illustrating a configuration related to DSP activation in a transmission apparatus according to Embodiment 2;

FIG. 12 is a flowchart illustrating an exemplary control process executed by an activation control processor of the transmission apparatus according to Embodiment 2;

FIG. 13 is a flowchart illustrating an exemplary control process executed by an activation control processor of a transmission apparatus according to Embodiment 3;

FIG. 14 is a flowchart illustrating an exemplary control process executed by an activation control processor of a transmission apparatus according to Embodiment 4; and

FIG. 15 is a diagram illustrating an exemplary application of the transmission apparatus according to the embodiments.

### DESCRIPTION OF EMBODIMENTS

### Embodiment 1

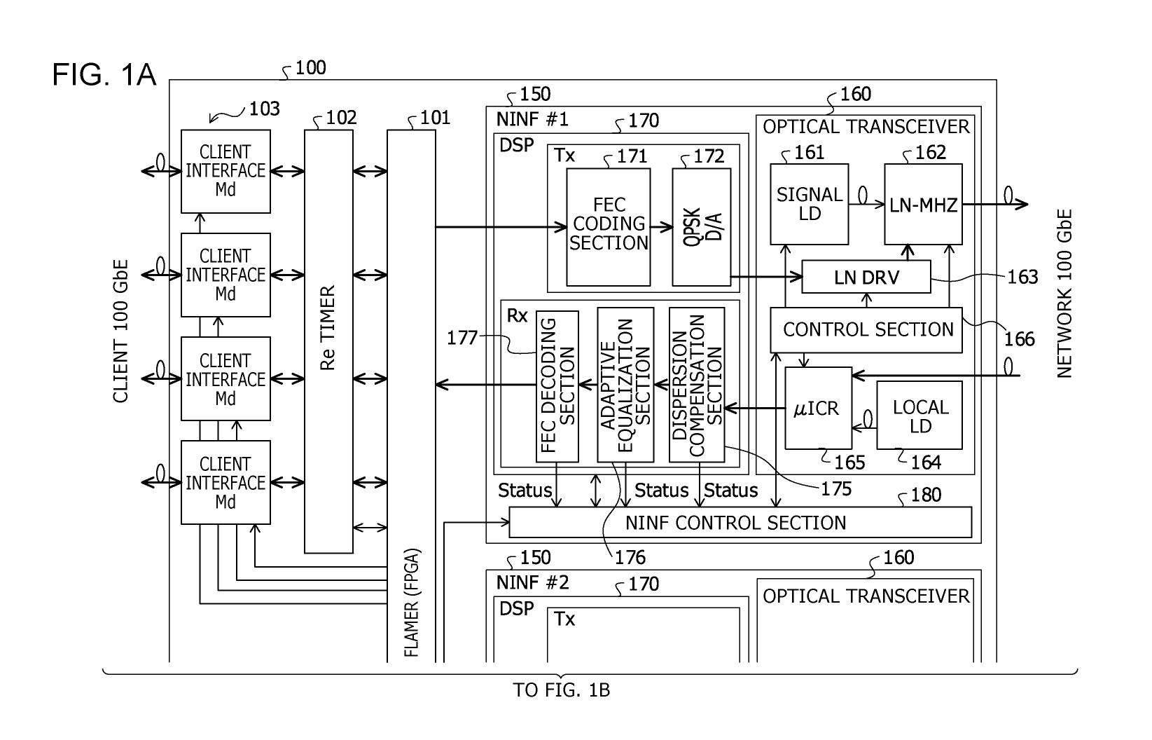

FIGS. 1A and 1B are block diagrams illustrating an exemplary internal configuration of a transmission apparatus according to Embodiment 1. An example will be described in which a transmitting and receiving apparatus (muxponder) 100 described above is treated as the transmission apparatus. The muxponder 100 is a system configuration which is expandable by inserting or removing multiple blades of network interfaces (NINFs) 150 with respect to slots inside a housing.

The muxponder 100 includes a framer 101, a retimer 102, client-side interfaces (IFs) 103, a control section 110, a power supply section 120, a power consumption monitor 121, and the above NINFs 150. The power consumption monitor includes a processor, and the processor may use any of a CPU, an FPGA, and a DSP.

The control section 110 controls the muxponder 100 overall. In Embodiment 1, the control section 110 includes a function of an activation control processor 111 that controls the activation of each NINF 150. The power supply section 120 includes a DC-DC converter 120 that outputs an operating power supply for each section based on a commercial power supply, for example. The power consumption monitor 121 monitors the overall power consumption of multiple DSPs 170 provided in the muxponder 100, and outputs monitoring information to the activation control processor 111. The processor 111 may use any of a CPU, an FPGA, and a DSP

The muxponder 100 transmits and receives optical signals (transmission signals) with respect to a network-side WDM apparatus through the multiple NINFs 150, for example, at a transmission rate of 100 Gbps through a single NINF 150. By installing additional NINFs 150, the transmission capacity with the WDM apparatus may be increased. Also, through a number of client-side IFs 103 provided in correspondence with the number of NINFs 150, electrical signals are transmitting and received with respect to routers, for example, at a transmission rate of 100 Gbps for a single client-side IF 103.

Signals (data) input and output inside the apparatus by the NINFs 150 are input and output with respect to client apparatus such as routers external to the apparatus through the framer 101, the retimer 102, and the client-side IFs 103. The framer 101 includes a function of a cross-connect that sets paths for input and output data to separate destinations, and frame processing of data. The framer 101 may use a field-programmable gate array (FPGA), for example.

The exemplary configuration of FIGS. 1A and 1B illustrates a state in which four NINFs 150 (#1 to #4) are installed. Each NINF 150 includes an optical transceiver 160, a processor (DSP) 170, and a NINF control section 180. The optical transceiver 160 inputs and outputs data (electrical signals) with respect to the DSP 170, and transmits and receives optical signals with respect to the network (WDM apparatus). The DSP 170 processes data transmitted and received by the optical transceiver 160.

As a configuration on the transmitting side, the optical transceiver 160 includes a signal laser diode (LD) 161, an LN Mach-Zehnder optical modulator 162, and an LN driver (DRV) 163. The signal LD 161 outputs carrier light to the Mach-Zehnder optical modulator 162. The LN driver 163 drives the optical modulation of the Mach-Zehnder optical modulator 162, and outputs an electrical signal (data) input from the DSP 170 to the Mach-Zehnder optical modulator 162 as data for transmission. Based on the input light and electrical signal (data), the Mach-Zehnder optical modulator 162 optically modulates and outputs the data to the network-side WDM apparatus.

As a configuration on the receiving side, the optical transceiver 160 includes a local LD 164 and a micro intradyne coherent receiver (μICR) 165. A control section 166 controls the transmitting and receiving of the optical transceiver 160. The receiver 165 converts a received optical signal into an electrical signal based on the wavelength of light from the local LD 164, and outputs the electrical signal to the DSP 170.

As a configuration on the transmitting side Tx, the DSP 170 includes an FEC coding section 171 and a QPSK modulation and D/A section 172. The FEC coding section 171 codes the data input from the framer while adding error correction bits. The QPSK modulation and D/A section 172 modulates the coded data according to the QPSK modulation scheme, converts the digital signal into an analog signal, and outputs the result as transmission data to the transmitter side of the transceiver.

As a configuration on the receiving side Rx, the DSP 170 includes a dispersion compensation section 175, an adaptive equalization section 176, and an FEC decoding section 177. The dispersion compensation section 175 compensates the received data output by the optical transceiver 160 for optical chromatic dispersion occurring in the optical transmission line or the like. The adaptive equalization section 176 restores data that has degraded during reception, based on a designated adaptive algorithm. The FEC decoding section 177 outputs data that has been bit-corrected by error detection to the framer 101.

The NINF control section 180 controls the optical transceiver 160 and the DSP 170 included in the NINF 150. In Embodiment 1, the NINF control section 180 acquires the status of each component on the receiving side of the DSP 170, and outputs to the activation control processor 111 of the control section 110. Also, the activation control processor 111 of the control section 110 outputs an activation control signal at an activation timing with respect to the NINF 150 determined to be activated, and the NINF control section 180 receives the input of the activation control signal, and controls the activation of its own NINF 150. The details of the activation control of the NINF 150 will be described later.

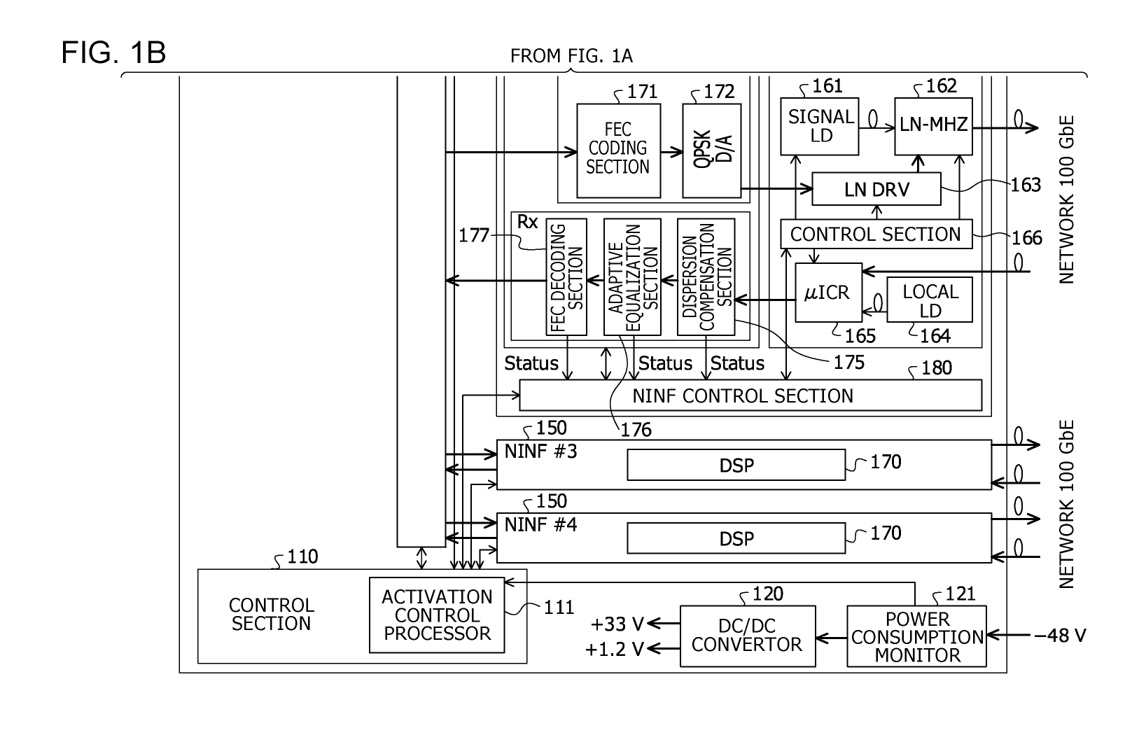

FIG. 2 is a block diagram illustrating a configuration related to DSP activation in the transmission apparatus according to Embodiment 1. For the sake of convenience, a single NINF 150 from among the multiple NINFs 150 illustrated in FIGS. 1A and 1B, and the activation control processor 111 of the control section 110 are illustrated.

The activation control processor 111 acquires and monitors monitor values of the status of each functional section on the receiving side Rx of the DSP 170 output by the NINF control section 180 of the DSP 170 of the multiple NINFs 150 provided in the muxponder 100. For example, the monitor values indicate a value corresponding to the state transition (such as activated or process complete) of each functional section.

The dispersion compensation section 175 provided in the receiving side Rx of the DSP 170 take a certain amount of time to compensate for optical chromatic dispersion in the received optical signal. The received data is successively output to the adaptive equalization section 176 and the FEC decoding section 177 after the dispersion compensation by the dispersion compensation section 175, and a certain amount of processing time is also taken in these functional sections.

The activation control processor 111 includes a NINF communication section 201, a status monitoring section 202, an activation determination section 203, an x monitoring timer 204, and a t standby timer 205. The NINF communication section 201 acquires the monitor values output by the DSPs 170 of the multiple NINFs 150. In Embodiment 1, monitor values of the dispersion compensation section 175 of the DSPs 170 primarily are acquired.

The status monitoring section 202 monitors the status of the functional sections of each DSP 170 by the acquired monitor values of the multiple DSPs 170. At this time, the status monitoring section 202 executes monitoring by referencing count values of the x monitoring timer 204 and the t standby timer 205 for every single DSP 170 being monitored. The x monitoring timer 204 counts the number of monitor checks, while in the t standby timer 205, a set time (standby time) for the activation timing of the DSP 170 to be activated next is set. For example, when the number of monitor checks counted by the x monitoring timer 204 is a certain prescribed value or greater, the status monitoring section 202 determines that the status is that the target DSP 170 has not executed a certain state transition, and outputs an alarm.

The activation determination section 203 determines the activation timing of each of the multiple DSPs 170, based on the status of the multiple DSPs 170 output by the status monitoring section 202. The activation determination section 203 outputs the determined activation timing of each of the multiple DSPs 170 as an activation control signal. At this time, the NINF communication section 201 outputs the activation control signal to the DSP 170 (NINF 150) indicated by the activation control signal.

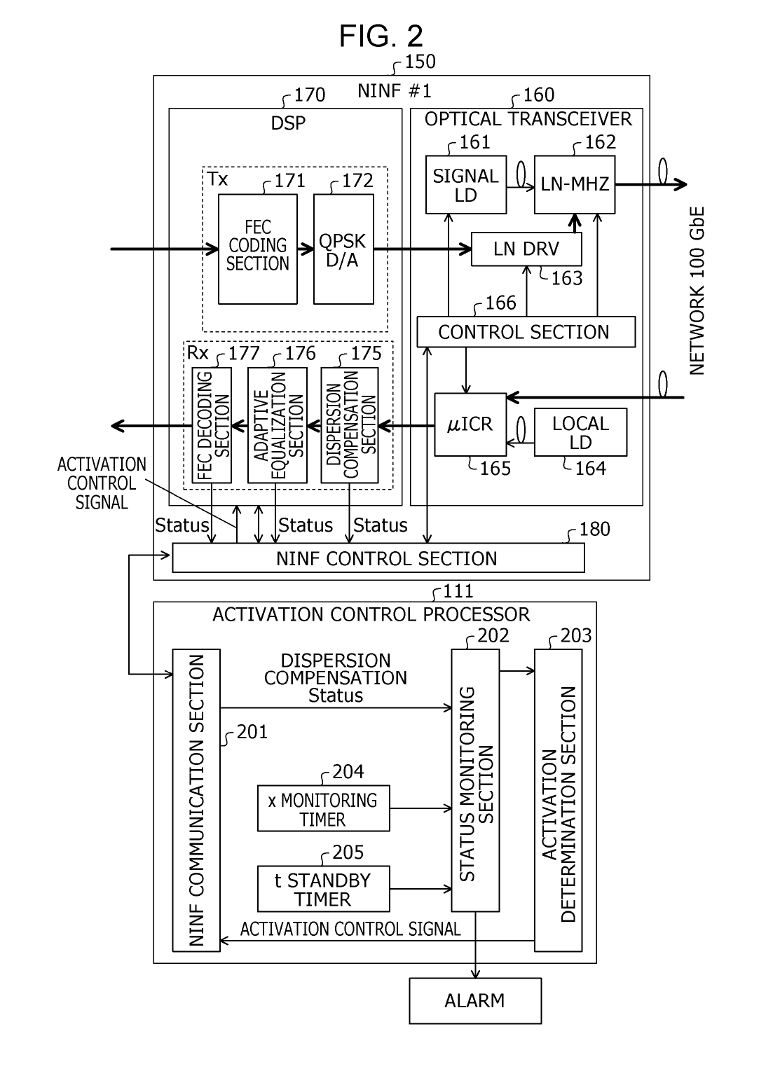

FIG. 3 is a diagram illustrating an exemplary hardware configuration of a control section of the transmission apparatus according to Embodiment 1. The control section 110 illustrated in FIGS. 1A and 1B (the activation control processor 111 of FIG. 2) is realized by having the central processing unit (CPU) 301 illustrated in FIG. 3 read out and execute a program stored in the memory 302. At this time, the CPU 301 uses the memory 302 as a work area. The memory may use ROM, RAM, flash ROM, and the like. Also, extended memory 303 such as an HDD may also be used as a data storage area or the like. The 304 is a bus. The communication section 305 constitutes the NINF communication section 201 illustrated in FIG. 2, and is a communication interface for receiving monitor values (status) and transmitting the activation control signal with respect to the multiple DSPs 170.

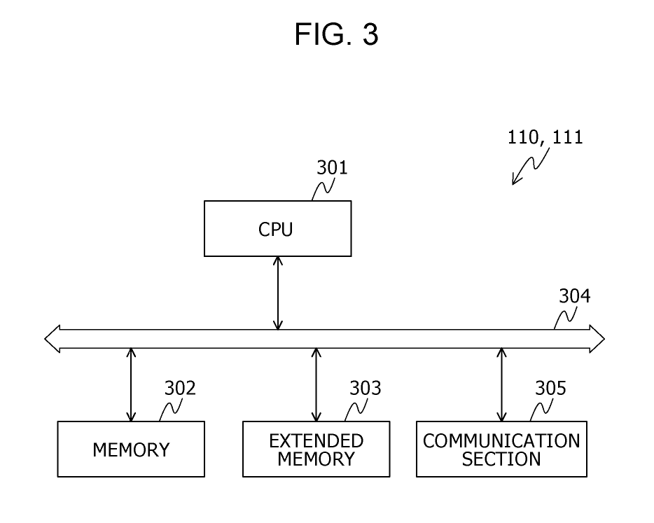

FIG. 4 is a flowchart illustrating an exemplary control process executed by an activation control processor of the transmission apparatus according to Embodiment 1. The content of the processing executed by the CPU 301 constituting the activation control processor 111 illustrated in FIG. 2 is illustrated. In each process, i represents an identification number of the DSP 170 inside the muxponder 100, x represents the monitor check count, n represents the maximum number of the DSPs 170 inside the muxponder 100, and t represents the set time.

First, the activation control processor 111 sets i (the DSP identification number) to an initial value of 1 (step S401), and activates DSP i (170) (step S402). Next, the activation control processor 111 sets x (the monitor check count) to an initial value of 0 (step S403), and determines whether the status indicated by the monitor value of the dispersion compensation section 175 for the target DSP 170 is an expected specific value (step S404). The specific value is, for example, a value indicating that the dispersion compensation section 175 has completed the dispersion compensation process after activating normally.

In the process of step S404, if the monitor value is the expected specific value (step S404: Yes), the activation control processor 111 determines whether i (the DSP identification number) being processed is 1 (the DSP 170 activated first) (step S405). If i=1 (step S405: Yes), the flow proceeds to the process in step S407. Also, if i≠1 (step S405: No), the activation control processor 111 stands by for the certain standby time t set in the t standby timer 205 (step S406), and after that, proceeds to the process in step S407.

Next, the activation control processor 111 determines whether i=n (step S407). In other words, it is determined whether the activation control process has finished for all DSPs. If i=n (step S407: Yes), the activation control processor 111 ends operations. If i≠n (step S407: No), i is incremented (step S408), and the flow returns to the process of step S402.

Also, if the monitor value in the process of step S404 is not the expected specific value (step S404: No), the activation control processor 111 determines if x (the monitor check count) counted by the x monitoring timer 204 is a certain prescribed value or greater (step S409). If x is less than the prescribed value (step S409: No), x is incremented (step S410), and the flow returns to the process of step S404. If x is the prescribed value or greater (step S409: Yes), the activation control processor 111 determines that there is an abnormality in the state transition of the DSP 170, outputs an alarm as a notification (step S411), and ends the process.

### Comparison of Existing Technology and Embodiment 1

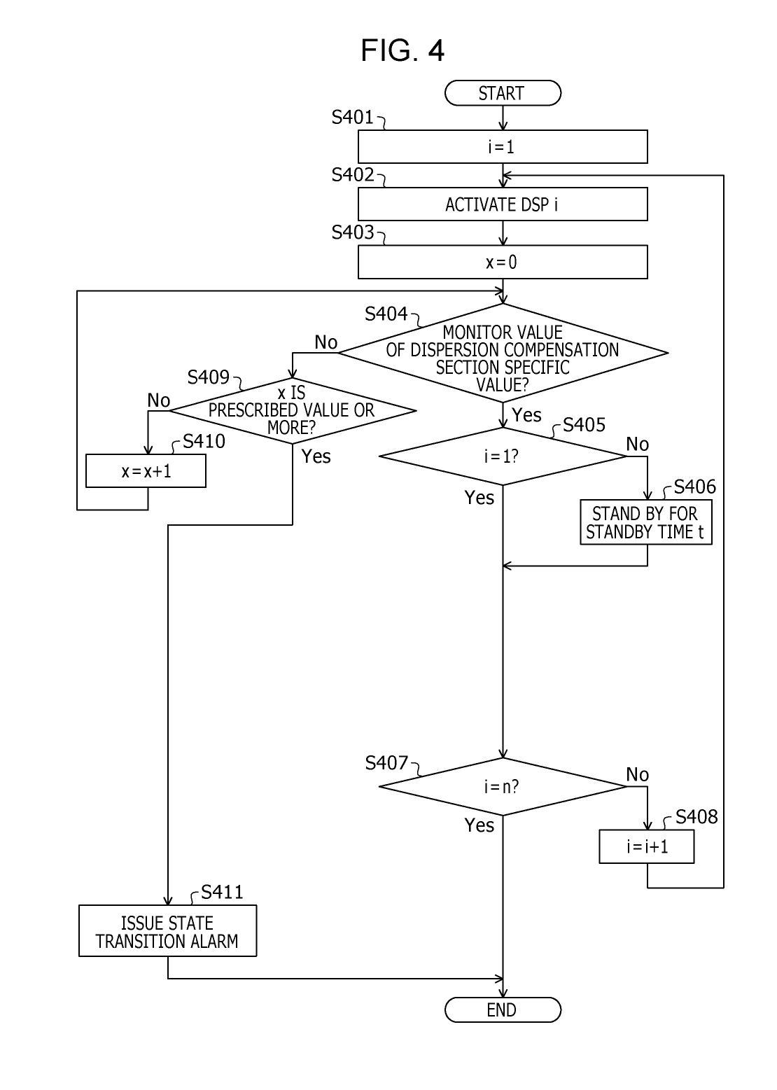

Herein, a comparison of the power consumption and activation completion time between existing technology and Embodiment 1 will be described. FIG. 5 is a graph illustrating the power consumption of an existing FEC processing section. The horizontal axis is the bit error rate of the optical transmission line, while the vertical axis is power consumption. The power consumption corresponding to the FEC decoding section 177 of Embodiment 1 is illustrated. The power consumption of the FEC processing section varies depending on the bit error rate on the optical transmission line of the received optical signal, or in other words, the number of error corrections processed by the FEC processing section. As the bit error rate rises, the computational complexity of the correction increases, and a sudden increase in the power consumption is illustrated.

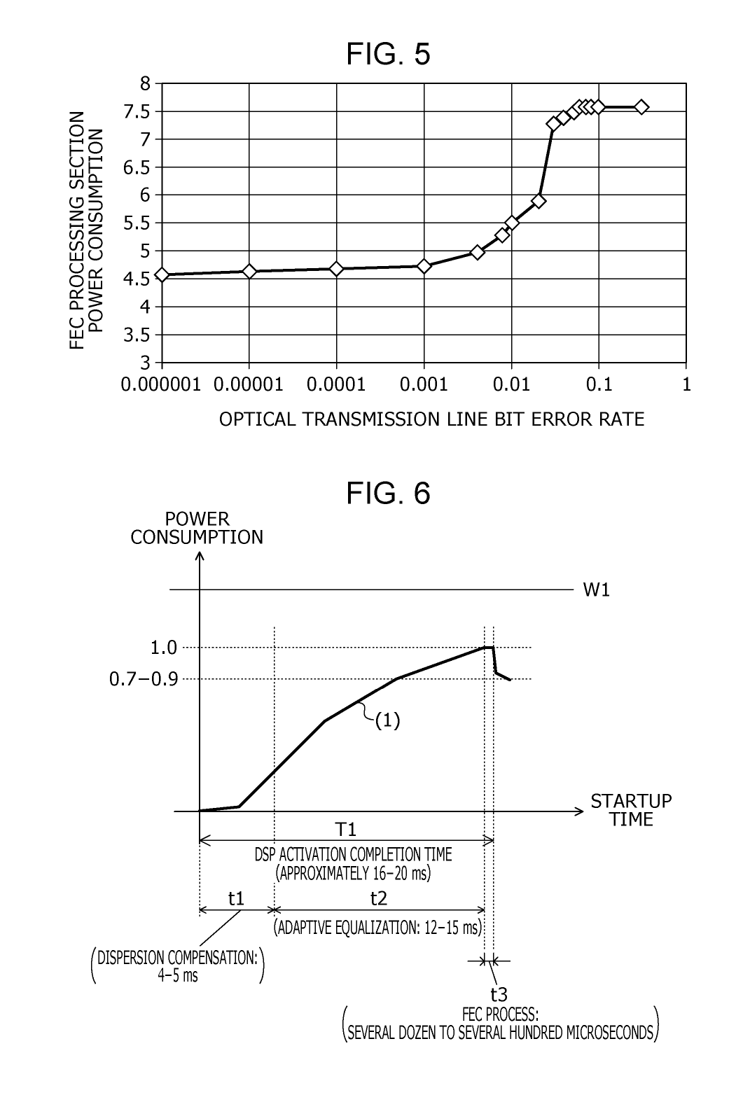

FIG. 6 is a time chart illustrating the transition of power consumption in an existing DSP. The horizontal axis indicates the startup time, while the vertical axis indicates the power consumption. For the sake of convenience, transitions in the power consumption will be described using the signs corresponding to each component (the dispersion compensation section 175, the adaptive equalization section 176, and the FEC decoding section 177) on the receiving side Rx of the DSP 170 in Embodiment 1. W1 is the maximum rating (power consumption) demanded by a single DSP 170.

After activation, the DSP 170 first takes a time t1 to execute the dispersion compensation process by the dispersion compensation section 175, takes a time t2 to execute the adaptive equalization process by the adaptive equalization section 176, and takes a time t3 to execute the FEC process by the FEC decoding section 177. For the DSP 170, the time from the start of activation until the process in each section is completed becomes an activation completion time T1 (for example, from 16 ms to 20 ms). Additionally, there is a characteristic (1) in which the power consumption increases over time during the execution of the processes in each of these sections. Herein, among the component sections included in the muxponder 100, the receiving section Rx of the DSP 170 exhibits the greatest variation in power consumption.

For this reason, in Embodiment 1, by monitoring the process status of each functional section in the receiving section Rx of the DSP 170, the activation timings with respect to multiple DSPs 170 are controlled.

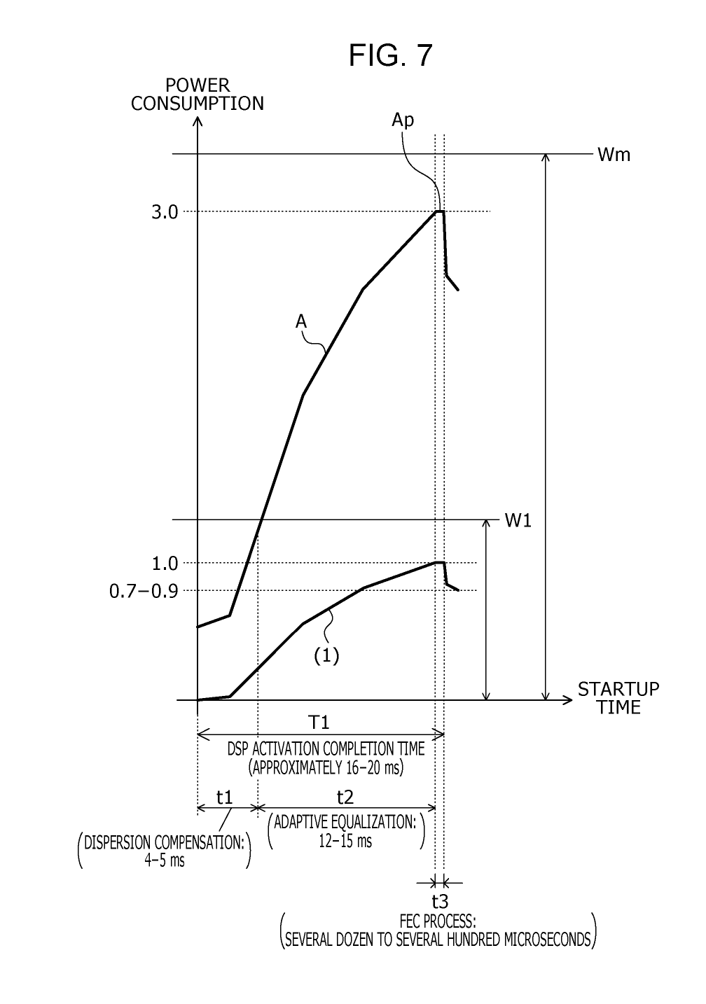

FIG. 7 is a time chart illustrating the transition of power consumption in the case of activating multiple existing DSPs. The characteristic (A) in the case of activating three DSPs 170 at the same time is illustrated. Wm is the maximum rating (power consumption) demanded by the three DSPs 170. As illustrated in FIG. 7, the characteristic A when activating three DSPs 170 (instantaneous maximum power consumption: peak Ap) has the characteristic of being three times the power consumption of the characteristic (1) of a single DSP 170. Note that to activate three DSPs 170 at the same time, the activation completion time T1 is similar to the case of a single DSP (see FIG. 6).

In this way, in the case of activating multiple DSPs 170 at the same time, the power consumption becomes the power consumption per DSP 170 multiplied by the number of activated DSPs, and the instantaneous maximum power consumption becomes large. Correspondingly, in the existing technology, a large maximum rating (power consumption) is set.

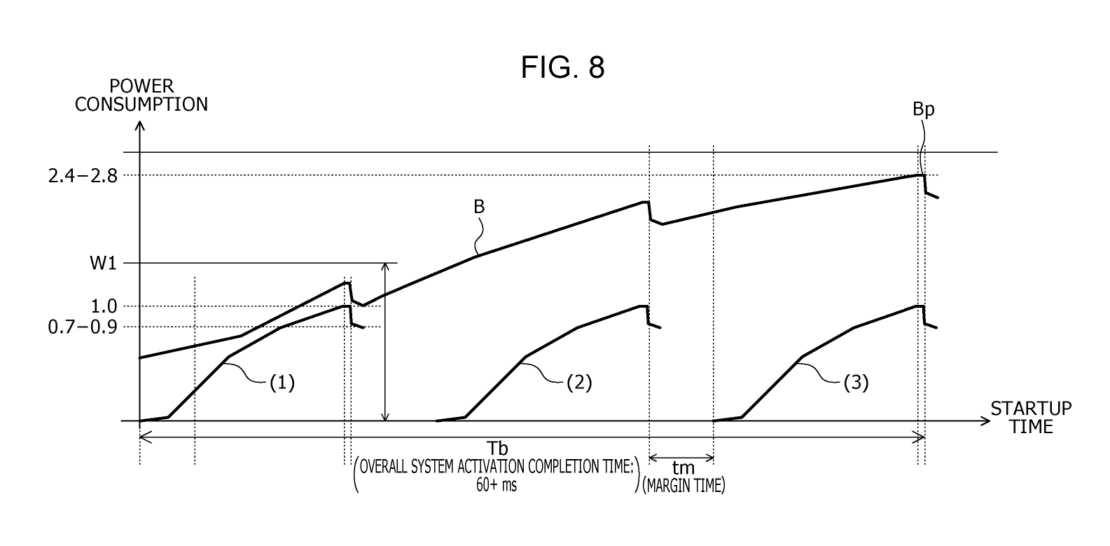

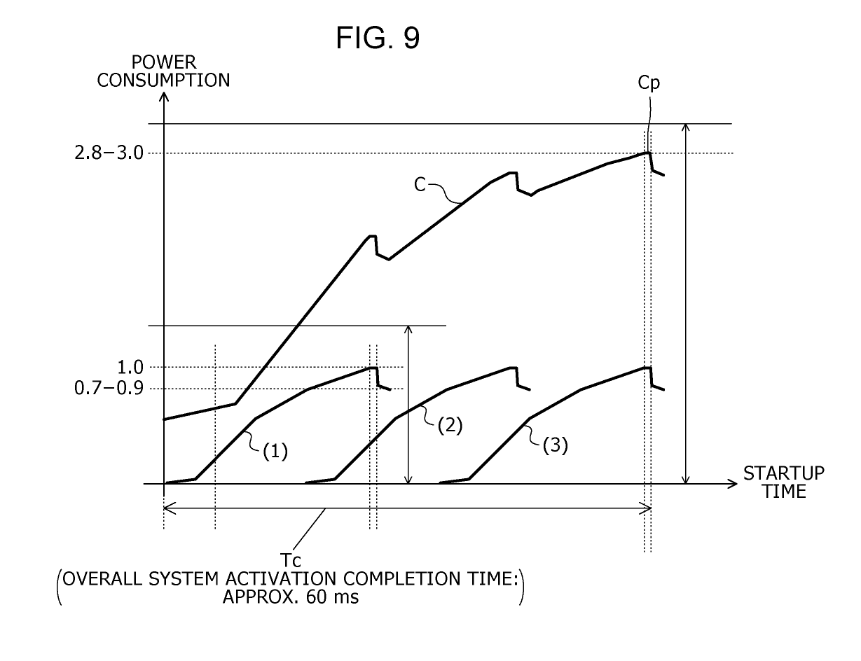

FIGS. 8 and 9 are time charts illustrating exemplary control of power consumption reduction in the case of activating multiple existing DSPs. As illustrated in FIG. 7, in the case of activating three DSPs 170 at the same time, the power consumption increases by the number of activated DSPs 170. To curtail this increase in the power consumption, the example of FIG. 9 is a state of successively executing activation control in which the process executed by a DSP (1) activated first is completed, and then the next DSP (2) is activated.

In this way, after the completion of the process by the DSP 170 activated first, the next DSP 170 is activated after a margin time tm elapses. The margin time tm uses a timer, for example. In this way, each of the DSPs (1) to (3) is activated successively at timings so that the activation timings (processes) by the multiple DSPs (1) to (3) do not overlap. With this arrangement, the characteristic B of the power consumption demanded by the three DSPs (1) to (3) overall may be reduced to a peak (instantaneous maximum power consumption) Bp. Compared to the power consumption peak Ap in FIG. 7, the power consumption peak Bp in FIG. 8 may be lowered.

However, in the example of FIG. 8, the activation completion time Tb increases compared to the example of FIG. 7. Compared to the activation completion time T1 of the simultaneous activation in FIG. 7, the activation completion time Tb takes three times as much time (for example, 60 ms or more).

In this way, with a control that simply offsets the activation timings of the multiple DSPs 170, although the power consumption may be reduced, the demanded specifications of the system with regard to startup time may no longer be satisfied.

For example, in the case of a communication rate of 100 Gbps, the activation completion time T1 from the start of activation until the completion of activation for a single DSP 170 has a processing time approximately from 16 ms to 20 ms (see FIG. 6). Like the description of FIG. 8, in the case of considering the activation of multiple DSPs 170, suppose that the startup of the DSPs 170 to activate are offset from each other, so that after the process of one DSP (1) is completed, the next DSP (2) is activated. In this case, the activation completion time increases by (16 ms to 20 ms)×(the number of DSPs to activate), including the margin time tm until each of the DSPs (1) to (3) activate, and for the multiple DSPs 170 overall, a total delay from several dozen milliseconds to several hundred milliseconds is produced. In this way, in a 100 Gbps system, if a delay on the order of several dozen milliseconds to several hundred milliseconds is produced, the demanded specifications of the muxponder 100 are no longer satisfied.

Also, the example of FIG. 9 illustrates a characteristic C of the power consumption in the case of successively executing activation control in which the next DSP (2) is activated before the completion of the processing by the DSP (1) activated first. For example, the next DSP (2) is activated while the adaptive equalization process is being executed by the DSP (1) activated first. In this way, if the activation timings of the multiple DSPs (1) to (3) are simply offset, the peak Cp in the power consumption of the multiple DSPs (1) to (3) may be made not to overlap at the same time. However, the activation completion time Tc (for example, approximately 60 ms) is still unable to satisfy the demanded specifications of the system.

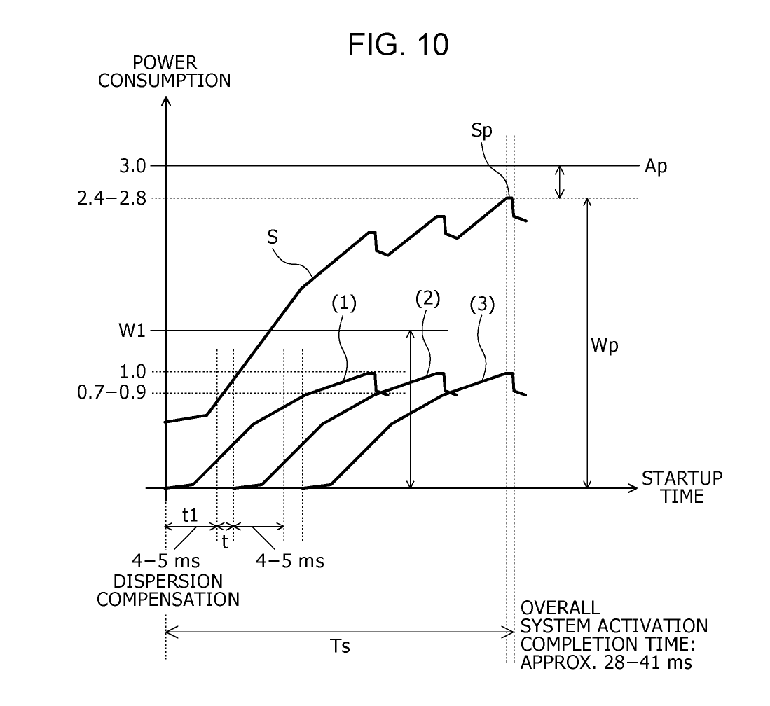

FIG. 10 is a time chart explaining exemplary control of DSP activation by the transmission apparatus according to Embodiment 1. The horizontal axis is the startup time, while the vertical axis is the power consumption. The time taken for activation and the power consumption will be described for the case in which the activation control processor 111 described earlier activates the three DSPs 170 of the NINFs 150. The DSPs (1) to (3) each increase in power consumption in association with the processing after activation (see FIG. 6).

During the activation of the first DSP (1), after the dispersion compensation section 175 activates normally, the dispersion compensation takes a certain time t1 (for example, 4 to 5 ms). After the completion of dispersion compensation in the dispersion compensation section 175, the activation control processor 111 activates the second DSP (2) to be activated next after standing by for a standby time t set in the t standby timer 205. By providing the standby time t, it is possible to avoid an overlap between the power consumption peak of the DSP (1) and the power consumption peak of the second DSP (2) due to fluctuations in the activation time of the adaptive equalization section 176 after the completion of dispersion compensation by the dispersion compensation section 175 in the DSP (1).

Additionally, as illustrated in FIG. 10, the activation control processor 111, based on the completion of the activation of the DSP (1) to activate first and the completion of the dispersion compensation process, repeats activation with the next DSP (2) after the standby time t. With this arrangement, the power consumption Wp of the power consumption S for the DSPs (1) to (3) overall (instantaneous maximum power consumption: peak Sp) may be reduced remarkably compared to the power consumption W1 (peak Ap) for simultaneous activation (see FIG. 7).

Also, since each the three DSPs (1) to (3) is activated with the activation timings offset from each other, the activation completion time Ts may be shortened. In the example of FIG. 8, the activation completion time T3 takes 60 ms or more, and the example of FIG. 9 takes approximately 60 ms, but in Embodiment 1 (FIG. 10), the activation completion time Ts may be shortened to a range from 28 ms to 41 ms.

Also, in Embodiment 1, rather than a configuration that simply stands by for the margin time tm in FIG. 8, the activation of the next DSP (2) is determined based on the status of the DSP (1) activated first. With this arrangement, it is possible to accommodate variations in the processing time in the DSP (1) activated first.

For example, in the case in which the dispersion compensation section 175 takes a certain amount of time to compensate for optical chromatic dispersion in the received optical signal, the transmission line is long, or the like, the time taken to execute the dispersion compensation process becomes correspondingly longer in correspondence with the length of the transmission line. In this way, the processing time on the receiving side Rx executed by the DSP 170 varies, but the activation control processor 111 computes the activation timing of the DSP 170 to activate next based on the status of each processing function in the DSP 170.

According to Embodiment 1 as described above, the activation timings of the multiple DSPs 170 may be executed at optimal timings in accordance with the actual processing status of each DSP 170. Even in the case of executing processing by multiple DSPs 170, the overall power consumption of the multiple DSPs 170 may be reduced while still satisfying the demanded startup time for the system. With this arrangement, even if additional NINFs 150 including the DSPs 170 are installed, the power consumption of the DSPs 170 is leveled, the rated power of the blades (NINFs 150) with the DSPs 170 onboard may be reduced, and in addition, the activation time of the DSPs 170 may be shortened.

### Embodiment 2

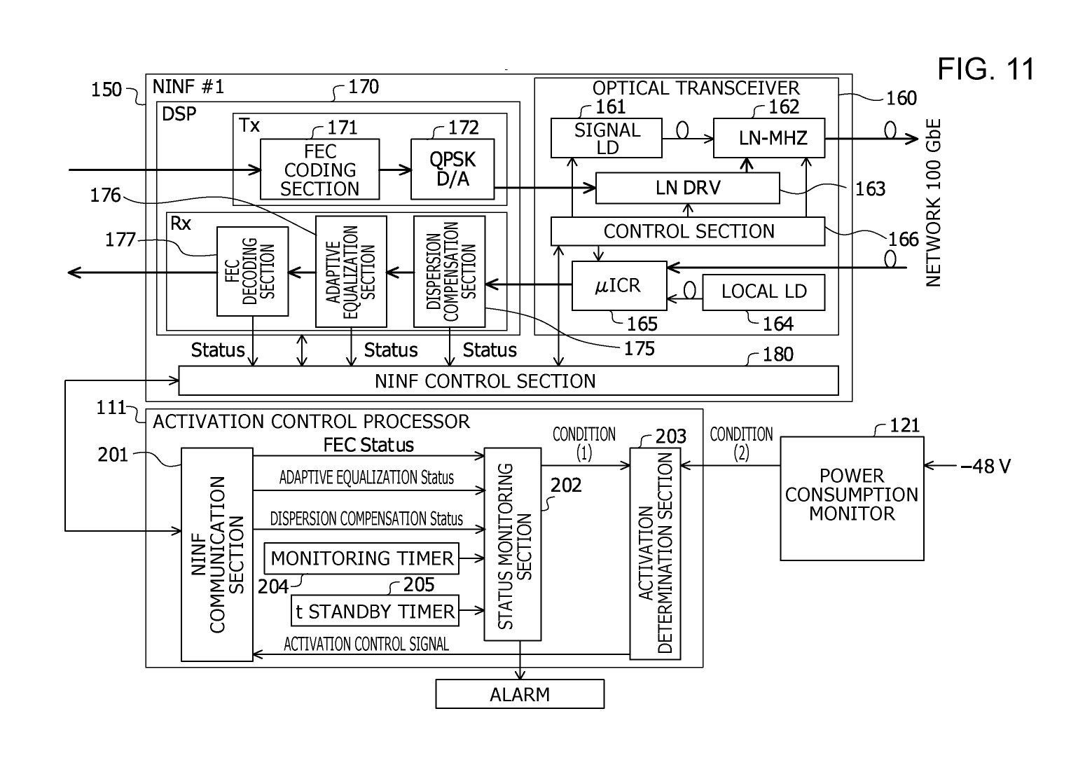

FIG. 11 is a block diagram illustrating a configuration related to DSP activation in the transmission apparatus according to Embodiment 2. The basic configuration of the muxponder 100 is similar to Embodiment 1 (FIGS. 1A, 1B, and 2), and like components are denoted with like signs. In Embodiment 2, in addition to the configuration of Embodiment 1, the activation control processor 111 acquires additional information (status). The monitoring timer 204 counts x and y values individually.

The activation control processor 111 acquires monitor values of the status of each functional section on the receiving side Rx of the DSP 170 output by the NINF control section 180 of the DSP 170 of the multiple NINFs 150 provided in the muxponder 100. For example, the monitor values indicate a value corresponding to the state transition (such as activated or process complete) of each functional section.

In Embodiment 2, the status monitoring section 202 of the activation control processor 111 monitors the status of the dispersion compensation section 175 of each DSP 170, and a monitor value of the overall power consumption of the multiple DSPs 170 monitored by the power consumption monitor 121.

The activation determination section 203 treats the status of the dispersion compensation section 175 of the multiple DSPs 170 output by the status monitoring section 202 as a condition (1), and treats the power consumption of the apparatus as a whole monitored by the power consumption monitor 121 as a condition (2). Additionally, the activation timing of each of the multiple DSPs 170 is determined by the combination of these conditions (1) and (2).

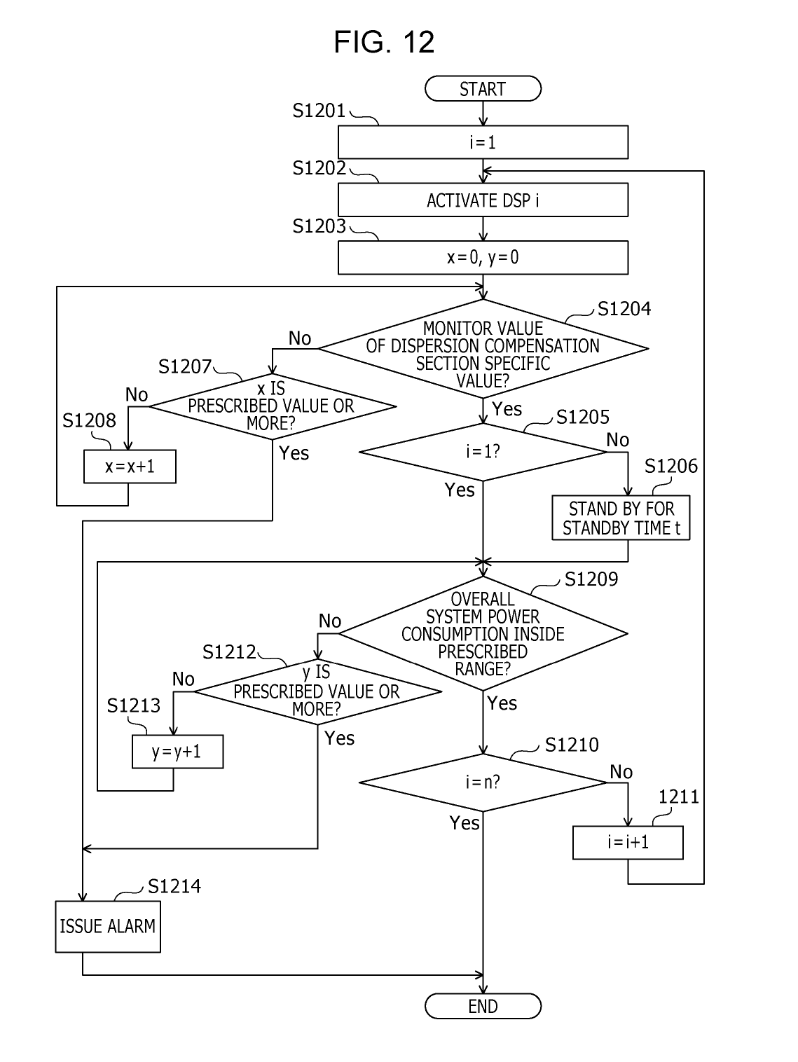

FIG. 12 is a flowchart illustrating an exemplary control process executed by an activation control processor of the transmission apparatus according to Embodiment 2. The content of the processing executed by the CPU 301 (see FIG. 3) constituting the activation control processor 111 illustrated in FIG. 11 is illustrated. In each process, i represents an identification number of the DSP 170 inside the muxponder 100, x represents a monitor check count (dispersion compensation process), y represents a monitor check count (overall system power consumption), n represents the maximum number of the DSPs 170 inside the muxponder 100, and t represents the set time.

First, the activation control processor 111 sets i (the DSP identification number) to an initial value of 1 (step S1201), and activates DSP i (170) (step S1202). Next, the activation control processor 111 sets x and y (the monitor check counts) to initial values of 0 (step S1203), and determines whether the status indicated by the monitor value of the dispersion compensation section 175 for the target DSP 170 is an expected specific value (determination of condition 1: step S1204). The specific value is, for example, the value of a process completion flag indicating that the dispersion compensation section 175 has completed the dispersion compensation process after activating normally.

In the process of step S1204, if the monitor value is the expected specific value (step S1204: Yes), the activation control processor 111 determines whether i (the DSP identification number) being processed is 1 (the DSP 170 activated first) (step S1205). If i=1 (step S1205: Yes), the flow proceeds to the process in step S1209. Also, if i≠1 (step S1205: No), the activation control processor 111 stands by for the certain standby time t set in the t standby timer 205 (step S1206), and after that, proceeds to the process in step S1209.

Also, if the monitor value in the process of step S1204 is not the expected specific value (step S1204: No), the activation control processor 111 determines if x (the monitor check count) counted by the monitoring timer 204 is a certain prescribed value or greater (step S1207). If x is less than the prescribed value (step S1207: No), x is incremented (step S1208), and the flow returns to the process of step S1204. If x is the prescribed value or greater (step S1207: Yes), the activation control processor 111 determines that there is an abnormality in the state transition of the DSP 170, outputs an alarm as a notification (step S1214), and ends the process.

Also, in step S1209, the activation control processor 111 determines whether the overall power consumption for the system, that is, for the multiple DSPs 170 provided in the muxponder 100, is inside a prescribed range (determination of condition 2: step S1209). As described earlier, for example, the upper limit value of the prescribed range is set to the value of the demanded maximum rating (power consumption) Wm or less, based on the peak Sp (see FIG. 10) in the power consumption corresponding to the number of DSPs 170 when multiple DSPs 170 are provided.

If the overall power consumption of the DSPs 170 is inside the prescribed range (step S1209: Yes), the flow proceeds to the process of step S1210. If the overall power consumption of the DSPs 170 exceeds the prescribed range (step S1209: No), the flow proceeds to the process of step S1212.

In step S1210, the activation control processor 111 determines whether i=n (step S1210). In other words, it is determined whether the activation control process has finished for all DSPs. If i=n (step S1210: Yes), the activation control processor 111 ends operations. If i≠n (step S1210: No), i is incremented (step S1211), and the flow returns to the process of step S1202.

In step S1212, the activation control processor 111 determines whether y (the monitor check count) counted by the monitoring timer 204 in the case in which y is not a prescribed value or greater is a certain prescribed value or greater (step S1212). If y is less than the prescribed value (step S1212: No), y is incremented (step S1213), and the flow returns to the process of step S1209. If y is the prescribed value or greater (step S1212: Yes), the activation control processor 111 determines that the overall power consumption of the system (the power consumption of the multiple DSPs 170) has not remained inside a prescribed range for the time counted by the timer 204. Additionally, an alarm indicating that the power consumption of the DSPs 170 has exceeded the prescribed range is output as a notification (step S1214), and the process ends.

According to Embodiment 2 as described above, similarly to Embodiment 1, the activation timings of the multiple DSPs 170 may be executed at optimal timings in accordance with the actual processing status of each DSP 170. Even in the case of executing processing by multiple DSPs 170, the overall power consumption of the multiple DSPs 170 may be reduced while still satisfying the demanded startup time for the system.

Also, in Embodiment 2, the next DSP (2) may be activated when triggered not only by the completion of the dispersion compensation process in the DSP (1) activated first, but also a certain transition state during the dispersion compensation process, thereby enabling the next DSP to be activated sooner.

Furthermore, in Embodiment 2, since the overall power consumption of the system (multiple DSPs) is also monitored using a prescribed range, the overall power consumption of the system when activating the multiple DSPs 170 may be leveled. Additionally, the maximum rating (power consumption) may also be lowered.

### Embodiment 3

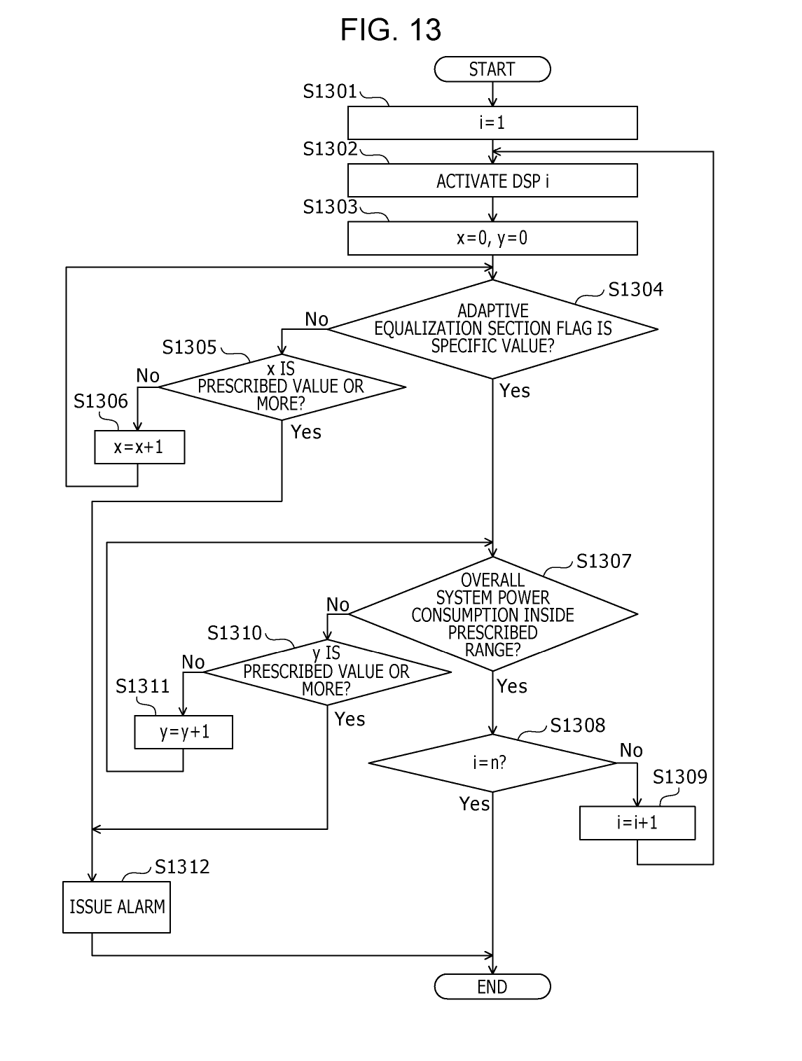

FIG. 13 is a flowchart illustrating an exemplary control process executed by an activation control processor of the transmission apparatus according to Embodiment 3. The content of the processing executed by the CPU 301 (see FIG. 3) constituting the activation control processor 111 illustrated in FIG. 11 is illustrated. In each process, i represents an identification number of the DSP 170 inside the muxponder 100, x represents a monitor check count (adaptive equalization process), y represents a monitor check count (overall system power consumption), and n represents the maximum number of the DSPs 170 inside the muxponder 100.

In Embodiment 3, the standby time t is not counted, and the t standby timer 205 (see FIG. 2) may be omitted. In other words, in Embodiment 3, since the completion of the adaptive equalization process (see FIG. 6) which occupies much of the processing time on the receiving side Rx of the DSPs 170 is determined, and since the FEC process finishes in a short amount of time, the next DSP (2) may be activated without setting the standby time t.

In Embodiment 3, the activation determination section 203 of the activation control processor 111 treats the status of the adaptive equalization section 176 of each DSP 170 as condition 1. Also, the overall power consumption of the system monitored by the power consumption monitor 121 is treated as condition 2, and the activation timings of the multiple DSPs 170 are controlled by the combination of conditions 1 and 2.

First, the activation control processor 111 sets i (the DSP identification number) to an initial value of 1 (step S1301), and activates DSP i (170) (step S1302). Next, the activation control processor 111 sets x and y (the monitor check counts) to initial values of 0 (step S1303), and determines whether the status indicated by the monitor value of the adaptive equalization section 176 for the target DSP 170 is an expected specific value (determination of condition 1: step S1304). The specific value is, for example, the value of a process completion flag indicating that the adaptive equalization section 176 has completed the adaptive equalization process after activating normally.

If the monitor value in the process of step S1304 is the expected specific value (step S1304: Yes), the activation control processor 111 proceeds to the process of step S1307. Also, if the monitor value in the process of step S1304 is not the expected specific value (step S1304: No), it is determined if x (the monitor check count) counted by the monitoring timer 204 is a certain prescribed value or greater (step S1305). If x is less than the prescribed value (step S1305: No), x is incremented (step S1306), and the flow returns to the process of step S1304. If x is the prescribed value or greater (step S1305: Yes), the activation control processor 111 determines that there is an abnormality in the state transition of the DSP 170, outputs an alarm as a notification (step S1312), and ends the process.

In step S1307, the activation control processor 111 determines whether the overall power consumption for the system, that is, for the multiple DSPs 170 provided in the muxponder 100, is inside a prescribed range (determination of condition 2: step S1307).

If the overall power consumption of the DSPs 170 is inside the prescribed range (step S1307: Yes), the flow proceeds to the process of step S1308. If the overall power consumption of the DSPs 170 exceeds the prescribed range (step S1307: No), the flow proceeds to the process of step S1310.

In step S1308, the activation control processor 111 determines whether i=n (step S1308). In other words, it is determined whether the activation control process has finished for all DSPs. If i=n (step S1308: Yes), the activation control processor 111 ends operations. If i≠n (step S1308: No), the activation control processor 111 increments i (step S1309), and the flow returns to the process of step S1302.

In step S1310, the activation control processor 111 determines whether y (the monitor check count) counted by the monitoring timer 204 in the case in which y is not a prescribed value or greater is a certain prescribed value or greater (step S1310). If y is less than the prescribed value (step S1310: No), y is incremented (step S1311), and the flow returns to the process of step S1307. If y is the prescribed value or greater (step S1310: Yes), the activation control processor 111 determines that the overall power consumption of the system (the power consumption of the multiple DSPs 170) has not remained inside a prescribed range for the time counted by the timer 204. Additionally, an alarm indicating that the power consumption of the DSPs 170 has exceeded the prescribed range is output as a notification (step S1312), and the process ends.

According to Embodiment 3 as described above, similarly to Embodiment 1, the activation timings of the multiple DSPs 170 may be executed at optimal timings in accordance with the actual processing status of each DSP 170. Even in the case of executing processing by multiple DSPs 170, the overall power consumption of the multiple DSPs 170 may be reduced while still satisfying the demanded startup time for the system.

Also, in Embodiment 3, since the overall power consumption of the system (multiple DSPs) is also monitored using a prescribed range, the overall power consumption of the system when activating the multiple DSPs 170 may be leveled. Additionally, the maximum rating (power consumption) may also be lowered.

Additionally, in Embodiment 3, the next DSP (2) may be activated when triggered by the completion of the adaptive equalization process in the DSP (1) activated first, thereby enabling the next DSP (2) to be activated at the closest possible timing to the completion of processing in the DSP (1). Also, the timer for counting the standby time t used in Embodiments 1 and 2 may be omitted, thereby simplifying the configuration and processing.

### Embodiment 4

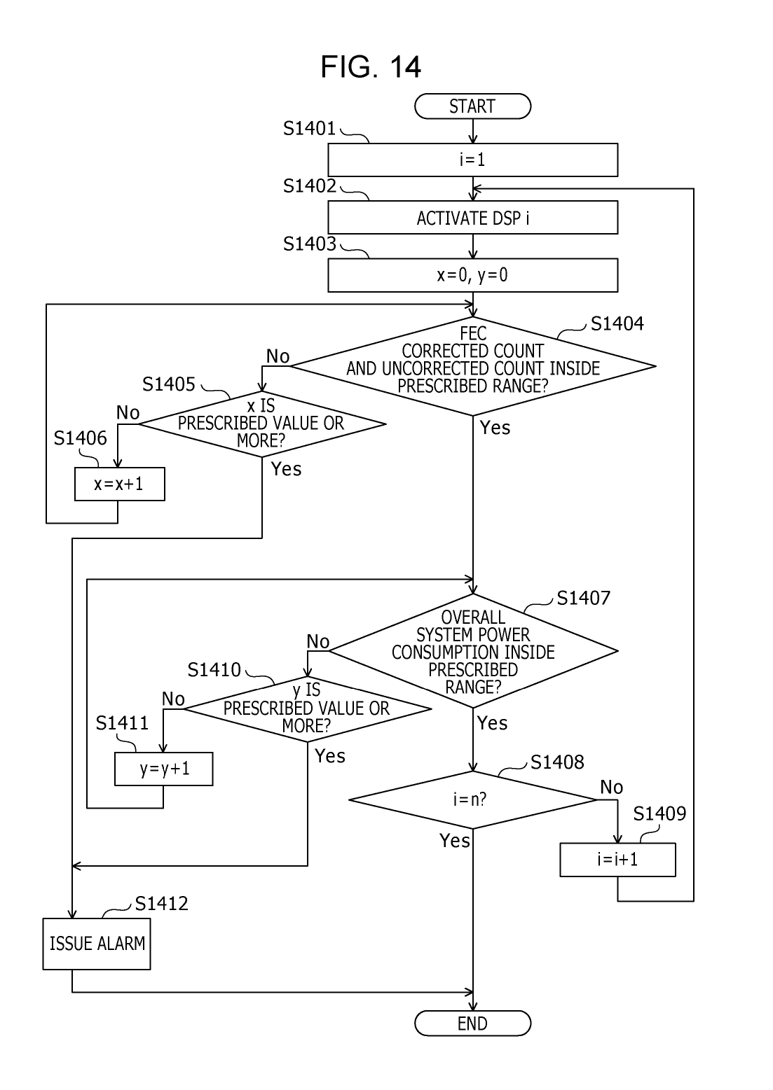

FIG. 14 is a flowchart illustrating an exemplary control process executed by an activation control processor of the transmission apparatus according to Embodiment 4. The content of the processing executed by the CPU 301 (see FIG. 3) constituting the activation control processor 111 illustrated in FIG. 11 is illustrated. In each process, i represents an identification number of the DSP 170 inside the muxponder 100, x represents a monitor check count (prescribed range of the FEC decoding corrected count and uncorrected count), y represents a monitor check count (overall system power consumption), and n represents the maximum number of the DSPs 170 inside the muxponder 100.

In Embodiment 4, the standby time t is not counted, and the t standby timer 205 (see FIG. 2) may be omitted. In other words, in Embodiment 4, since it is determined whether the FEC decoding process (see FIG. 6) that executes processing last on the receiving side Rx of the DSP 170 has completed normally, the next DSP (2) may be activated without setting the standby time t.

In Embodiment 4, the activation determination section 203 of the activation control processor 111 treats whether the FEC decoding corrected count and uncorrected count indicated by the status of the FEC decoding section 177 of the DSP 170 is a prescribed range as condition 1. Also, the overall power consumption of the system monitored by the power consumption monitor 121 is treated as condition 2, and the activation timings of the multiple DSPs 170 are controlled by the combination of conditions 1 and 2.

First, the activation control processor 111 sets i (the DSP identification number) to an initial value of 1 (step S1401), and activates DSP i (170) (step S1402). Next, the activation control processor 111 sets x and y (the monitor check counts) to initial values of 0 (step S1403). Additionally, the activation control processor 111 determines whether the status indicated by the monitor values of the FEC decoding section 177 of the target DSP 170, namely each of the FEC corrected count and uncorrected count, is inside a prescribed range (determination of condition 1: step S1404).

If the FEC decoding process is normal (each of the FEC corrected count and uncorrected count is inside the prescribed range) in step S1404 (step S1404: Yes), the activation control processor 111 proceeds to the process of step S1407. Also, if the FEC decoding process is not normal (the FEC corrected count or uncorrected count is outside the prescribed range) in step S1404 (step S1404: No), it is determined if x (the monitor check count) counted by the monitoring timer 204 is a certain prescribed value or greater (step S1405). If x is less than the prescribed value (step S1405: No), x is incremented (step S1406), and the flow returns to the process of step S1404. If x is the prescribed value or greater (step S1405: Yes), the activation control processor 111 determines that there is an abnormality in the status of the DSP 170, outputs an alarm as a notification (step S1412), and ends the process.

In step S1407, the activation control processor 111 determines whether the overall power consumption for the system, that is, for the multiple DSPs 170 provided in the muxponder 100, is inside a prescribed range (determination of condition 2: step S1407).

If the overall power consumption of the DSPs 170 is inside the prescribed range (step S1407: Yes), the flow proceeds to the process of step S1408. If the overall power consumption of the DSPs 170 exceeds the prescribed range (step S1407: No), the flow proceeds to the process of step S1410.

In step S1408, the activation control processor 111 determines whether i=n (step S1408). In other words, it is determined whether the activation control process has finished for all DSPs. If i=n (step S1408: Yes), the activation control processor 111 ends operations. If i≠n (step S1408: No), the activation control processor 111 increments i (step S1409), and the flow returns to the process of step S1402.

In step S1410, the activation control processor 111 determines whether y (the monitor check count) counted by the monitoring timer 204 in the case in which y is not a prescribed value or greater is a certain prescribed value or greater (step S1410). If y is less than the prescribed value (step S1410: No), the activation control processor 111 increments y (step S1411), and the flow returns to the process of step S1407. If y is the prescribed value or greater (step S1410: Yes), the activation control processor 111 determines that the overall power consumption of the system (the power consumption of the multiple DSPs 170) has not remained inside a prescribed range for the time counted by the timer 204. Additionally, an alarm indicating that the power consumption of the DSPs 170 has exceeded the prescribed range is output as a notification (step S1412), and the process ends.

According to Embodiment 4 as described above, similarly to Embodiment 1, the activation timings of the multiple DSPs 170 may be executed at optimal timings in accordance with the actual processing status of each DSP 170. Even in the case of executing processing by multiple DSPs 170, the overall power consumption of the multiple DSPs 170 may be reduced while still satisfying the demanded startup time for the system.

Also, in Embodiment 4, since the overall power consumption of the system (multiple DSPs) is also monitored using a prescribed range, the overall power consumption of the system when activating the multiple DSPs 170 may be leveled. Additionally, the maximum rating (power consumption) may also be lowered.

Additionally, in Embodiment 4, the next DSP (2) may be activated when triggered by the completion of the FEC decoding process in the DSP (1) activated first, thereby enabling the next DSP (2) to be activated on the completion of processing in the DSP (1). Also, the timer for counting the standby time t used in Embodiments 1 and 2 may be omitted, thereby simplifying the configuration and processing.

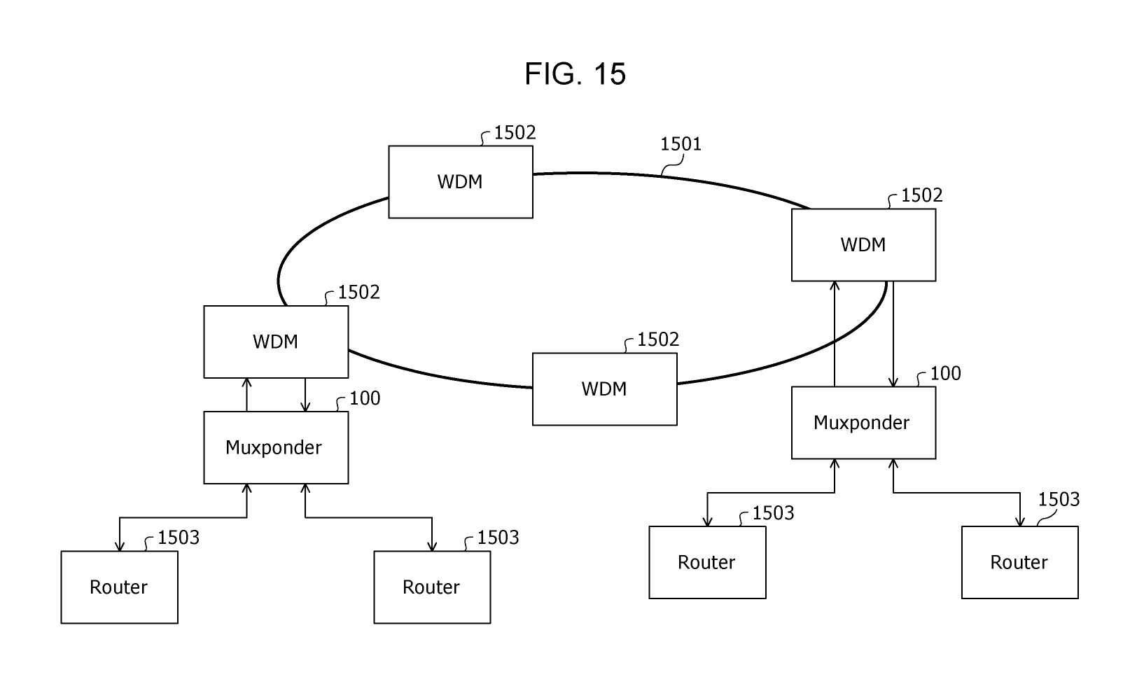

FIG. 15 is a diagram illustrating an exemplary application of the transmission apparatus according to the embodiments. The transmission apparatus (muxponder 100) according to the embodiments described above may be applied as a muxponder on a WDM network, for example.

On the WDM network 1501, multiple WDM apparatus 1502 are disposed, and optical signals transmitted over the WDM network 1501 are inserted and split by the WDM apparatus 1502. Connected to the WDM apparatus 1502 is a transmitting and receiving apparatus (muxponder) 100 that acts as the transmission apparatus described in the embodiments. One end of the muxponder 100 is connected to the WDM apparatus 1502, while the other end is connected to routers 1503 or the like. As illustrated in FIG. 15, the muxponder 100 inputs and outputs optical signals with respect to the WDM apparatus 1502, and inputs and outputs electrical signals with respect to the routers 1503 on the other end.

According to the embodiments described above, even in the case of installing additional processors, such as an arbitrary number of DSPs, in an apparatus with a blade configuration, increases in the power consumption of the DSPs may be avoided, while in addition, the time until DSP activation is completed may be shortened. An activation control processor monitors the operational status of the DSPs, activates a single DSP, and based on the operational status of data processing executed by the activated DSP, determines the activation timing of the DSP to activate next. The operational status of the DSP executes operational transitions such as activating, processing, and processing complete.

In the case in which a DSP receives an optical signal and processes received data, a dispersion compensation section that executes data processing for chromatic dispersion compensation of the received data is included. In this case, the activation control processor activates the next DSP after a standby time elapses from the completion of the data processing for chromatic dispersion compensation. Also, in the case in which the DSP includes an adaptive equalization section that executes data processing for adaptive equalization of received data, the activation control processor may activate the next DSP based on the completion of the data processing for adaptive equalization. Also, in the case in which the DSP includes an FEC decoding section that executes data processing for error correction of received data, the activation control processor activates the next DSP based on the completion of the data processing for error correction in the DSP. With this arrangement, the peaks in the power consumption of the multiple activated DSPs do not overlap, the instantaneous maximum power consumption may be reduced, and the rated power of the blades (NINFs) equipped with the DSPs may be reduced. Also, the demanded specifications for the processing time of received data may be satisfied.

Also, since the activation timing of the next DSP is determined based on the operational status of the DSP, in the case in which data processing in the DSP is time-consuming, the activation of the next DSP may be delayed by a corresponding amount. In this way, by determining the activation timing of the next DSP based on the operational status of multiple DSPs, compared to the case of simply activating the DSPs successively according to a timer or the like, it becomes possible to execute dynamic and flexible activation control matched to the actual operational status of the DSPs. With this arrangement, it is possible to address problems such as the increase in power consumption in the case of activating multiple DSPs simultaneously, and the longer overall activation time in the case of activating the next DSP after the completion of activation in one DSP.

Also, the activation control processor is able to monitor the operational status of the monitored DSPs and the total power consumption of the multiple DSPs, and output an alarm as a notification in the case of an abnormality. The activation control processor 111 activates the next DSP while monitoring to check that the total power consumption of the DSPs is inside a prescribed range. With this arrangement, it becomes possible to reduce the instantaneous maximum power consumption in the case of installing additional DSPs. Even with an apparatus which is expandable with additional blades including DSPs, it becomes possible to reduce the maximum power consumption in accordance with the expansion state, and the peak in the instantaneous maximum power consumption inside the apparatus may be lowered while also optimizing the activation timings of the multiple DSPs inside the apparatus. Additionally, it is also possible to accommodate the case in which multiple blades (NINFs) equipped with DSPs are installed arbitrarily in the apparatus, thereby making it possible to reduce the rated power for the blades as a whole, and lower the power consumption of the maximum rating demanded by the blades as a whole.

Also, although the foregoing embodiments describe a transmission apparatus that transmits signals as an example, the embodiments are not limited to signal transmission, and is also applicable similarly to the blades of an electronic device equipped with multiple insertable and removable DSPs 170 that execute certain data processing that is subject to monitoring and activation control. Additionally, the activation timing of the DSPs 170 may be controlled based on the status of each function included in the DSPs 170 and the monitoring of the power consumption of the DSPs as a whole. In this way, it is possible to obtain effects similar to those described above for the example of a transmission device, even in the case of applying an embodiment to a general electronic device.

Note that each operation associated with the activation control method described in the foregoing embodiments may be realized by having a computer (such as a CPU) of the target device or the like (the transmission device described above) execute a control program prepared in advance. The control program is recorded onto a computer-readable recording medium such as a magnetic disk, an optical disc, or Universal Serial Bus (USB) flash memory, and is executed by being read out from the recording medium by the computer. Also, the control program may be distributed over a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a processor that
monitors a first operational status of processors,
activates one of unactivated processors of the processors, and based on a second operational status of the activated processor, determines an activation timing of a next processor to activate next, and
activates the next processor at the activation timing.

2. The transmission apparatus according to claim 1, wherein
the activated processor receives a transmission signal, and executes received data processing, and
the processor determines the activation timing of the next processor based on a third operational status of the received data processing in the activated processor.

3. The transmission apparatus according to claim 2, wherein
the processor determines the activation timing of the next processor based on a completion of the data processing for chromatic dispersion compensation in the activated processor.

4. The transmission apparatus according to claim 3, wherein
the processor activates the next processor after a certain standby time elapses from the completion of the data processing for chromatic dispersion compensation in the activated processor.

5. The transmission apparatus according to claim 2, wherein
the activated processor executes data processing for adaptive equalization of the received data as the received data processing, and
the processor activates the next processor based on a completion of the data processing for adaptive equalization in the activated processor.

6. The transmission apparatus according to claim 2, wherein
the activated processor executes data processing for error correction of the received data as the received data processing, and
the processor activates the next processor based on a completion of the data processing for error correction in the activated processor.

7. The transmission apparatus according to claim 2, wherein
when the third operational status of the monitored activated processor after activation is a certain prescribed value or greater, the processor outputs an alarm regarding the data processing in the activated processor as a notification.

8. The transmission apparatus according to claim 1, further comprising:
a power consumption monitor that monitors a total power consumption of the processors as a whole, wherein
when the total power consumption is inside the certain prescribed range, the processor determines an activation timing of another processor to activate next, and activates the another processor at the activation timing.

9. The transmission apparatus according to claim 8, wherein
when a count of a number of times that the total power consumption is not contained inside a certain prescribed range exceeds a certain prescribed count, the processor outputs an alarm for indicating that the total power consumption of the processors as a whole is not contained inside a prescribed range as a notification.

10. The transmission apparatus according to claim 1, wherein
the transmission apparatus is expandable with multiple freely insertable and removable blades that additionally include one of the processors and an optical signal transceiver, and
the processor acquires information about the operational status of the data processing from each installed blade, determines the activation timing of each installed blade, and outputs a signal to each blade.

11. The transmission apparatus according to claim 1, wherein
the activated processor outputs information about state transitions include activating, processing, and processing complete to the processor as the operational status.

12. An electronic device comprising:
a processor that
monitors a first operational status of processors, provided inside the electronic device, that execute certain data processing,
activates one of unactivated processors of the processors, and based on a second operational status of the activated processor, determines an activation timing of a next processor to activate next, and
activates the next processor at the activation timing.

13. A method that executes processing repeatedly, comprising:
monitoring a first operational status of processors, provided inside an apparatus, that execute certain data processing with respect to a transmission signal,
activating one of unactivated processors of the processors, and based on a second operational status of the activated processor, determining an activation timing of a next processor to activate next, and
activating the next processor at the activation timing.
